(19) United States
(12) Patent Application Publication
(10) Pub. No.: US 2023/0052214 A1
(43) Pub. Date: Feb. 16, 2023

(54) ELECTRODE SHEET, WINDING BATTERY CORE, AND BATTERY

(71) Applicant: BYD COMPANY LIMITED, Shenzhen (CN)

(72) Inventors: Xinjun JIANG, Shenzhen (CN); Jian ZHANG, Shenzhen (CN); Lei LEI, Shenzhen (CN)

(21) Appl. No.: 17/977,043

(22) Filed: Oct. 31, 2022

Related U.S. Application Data
(63) Continuation of application No. PCT/CN2021/086147, filed on Apr. 9, 2021.

(30) Foreign Application Priority Data
May 9, 2020 (CN) 202020761606.8

(51) Int. Cl. H01M 4/70; H01M 50/46

(52) U.S. Cl. CPC H01M 4/70; H01M 50/46; H01M 2004/021

(57) ABSTRACT

An electrode sheet includes a current collector and a first active material layer coated on a first surface of the current collector. The first active material layer includes a first groove, and the first groove includes a first side wall, a second side wall, and a third side wall. The first side wall and the second side wall are arranged parallel to each other, and the third side wall connects the first side wall and the second side wall. The first groove has a width that is a distance from the first side wall to the second side wall, and a length of a surface contour of a cross-section view of the third side wall is greater than the width of the first groove.

### CROSS-REFERENCE TO RELATED APPLICATIONS

The application is a continuation application of International Patent Application No. PCT/CN2021/086147 filed with the China National Intellectual Property Administration (CNIPA) on Apr. 9, 2021, which is based on and claims priority to and benefits of Chinese Patent Application No. 202020761606.8 filed on May 9, 2020. The entire content of all of the above-referenced applications is incorporated herein by reference.

### FIELD

The present disclosure relates to the field of batteries, and specifically to an electrode sheet, a winding battery core, and a battery.

### BACKGROUND

A battery electrode sheet includes a current collector and an active material coated on a surface of the current collector. The current collector is generally an aluminum foil or a copper foil. In the current production process of the battery electrode sheet, the electrode sheet is rolled to obtain an electrode sheet that meets the design parameters.

### SUMMARY

To accomplish the objectives of the present disclosure, the present disclosure provides the following technical solutions.

In a first aspect, the present disclosure provides an electrode sheet, which includes a current collector and a first active material layer coated on a first surface of the current collector. The first active material layer comprises a first groove, and the first active material layer includes a first side wall, a second side wall and a third side wall. The first side wall and the second side wall are arranged parallel to each other, and the third side wall connects the first side wall and the second side wall. The first groove has a width that is a distance from the first side wall to the second side wall. A length of a surface contour of a cross-section view of the third side wall is greater than the width of the first groove.

In an embodiment, the surface contour includes a curve or a straight line.

In an embodiment, the curve includes a first arc or a combination of a straight line and a second arc.

In an embodiment, a radius of the first arc is half of the width of the first groove.

In an embodiment, the current collector includes a first side and a second side opposing to each other, the first groove extends in a direction from the first side towards the second side, and the curve is recessed towards the second side.

In an embodiment, the electrode sheet further includes a second active material layer, provided on a second surface of the current collector opposite to the first surface of the current collector, where the second active material layer comprises a second groove.

In an embodiment, the second groove and the first groove are arranged in alignment or to offset with each other.

In an embodiment, the second groove extends in a direction from the second side towards the first side.

In a second aspect, the present disclosure further provides a winding battery core, which includes a separator and two electrode sheets described in any one of the various embodiments according to the first aspect, where the separator is arranged between the two electrode sheets.

In a third aspect, the present disclosure provides a battery, which includes a winding battery core as described in the second aspect.

### BRIEF DESCRIPTION OF THE DRAWINGS

To describe the technical solutions in the embodiments of the present disclosure or in the prior art more clearly, the following briefly describes the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic of a structural view of a battery according to an embodiment;

FIG. 2 is a schematic of a structural view of a winding battery core according to an embodiment;

FIG. 3 is a schematic of a front structural view of an electrode sheet according to an embodiment;

FIG. 4 is a schematic of a bottom structural view of an electrode sheet according to an embodiment;

FIG. 5 is a schematic of a front structural view of an electrode sheet according to an embodiment;

FIG. 6 is a schematic of a front structural view of an electrode sheet according to an embodiment;

FIG. 7 is a schematic of a front structural view of an electrode sheet according to an embodiment;

FIG. 8 is a schematic of a front structural view of an electrode sheet according to an embodiment;

FIG. 9 is a schematic of a bottom structural view of an electrode sheet according to an embodiment; and

FIG. 10 is a schematic of a structural view of a battery according to an embodiment.

### REFERENCE NUMERALS

battery, K battery housing 100, winding battery core J, battery upper cover G, electrolyte injection port D, boss T1, cylindrical boss T2, electrode sheet 1 or 2, separator 3, current collector 10, the first active material layer 11 includes second active material layer 12, first groove C1, second groove C2, first side wall B1, second side wall B2, third side wall B3, profile L1 of the third side wall of the first groove, profile L2 of the third side wall of the second groove, width 4 of the first groove C1, first side 5, and second side 6.

### DETAILED DESCRIPTION

The following describes the technical solutions in the present disclosure with reference to the accompanying drawings in the implementations of the present disclosure. Apparently, the described embodiments are merely some but not all of the implementations of the present disclosure. Other embodiments obtained by a person of ordinary skill in the art based on the implementations of the present disclosure without creative efforts shall fall within the protection scope of the present disclosure.

During the rolling process to make a battery electrode sheet, the active material is pressed to make to it more condensed, which leads to the active material pressing the foil, eventually leading to the extension of the foil. Since no foil extension occurs at the position where no active material layer is coated, ripples and even wrinkles in severe cases are visible in appearance at the edge of the foil due to different extension at positions with or without the active material. Wrinkling of a groove in the electrode sheet would affect the welding strength of the tabs, causing poor welding or increasing the resistance of the battery, fast heat generation during the charge and discharge processes of the battery, and accelerated attenuation of the cycle life. At positions where the groove meets the active material, the active material tends to fall off, causing a serious quality problem to the electrode sheet of exposing the foil.

The present disclosure provides an electrode sheet, a winding battery core and a battery, to solve the problems of exposed foil of the battery electrode sheet, short cycle life of the battery core and fast heat generation of the battery caused by the wrinkling of the current collector during the rolling process of the electrode sheet.

The disclosed techniques provide the third side wall having a surface contour with a length that is greater than the width of the first groove such that when the perimeter of the first groove is extended, the area of the current collector at the first groove is increased. When rolled, the stressed area of the current collector at the first groove is increased, the pressure transmitted via the active material layer to the current collector per unit area is reduced, so that the current collector is less extended, and the wrinkling of the current collector is reduced.

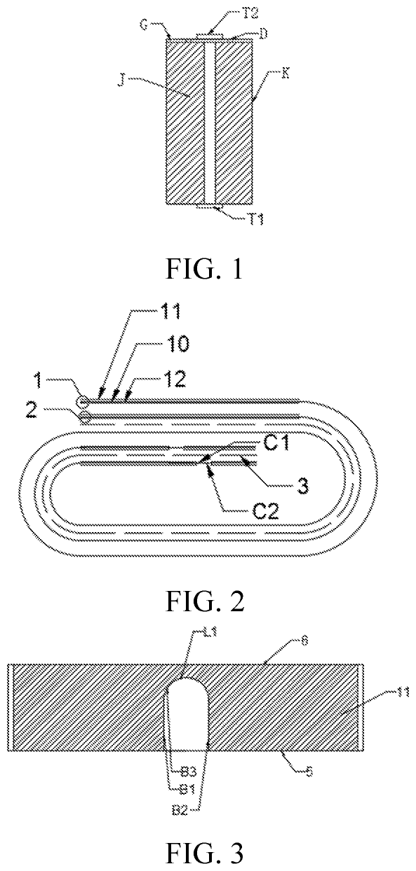

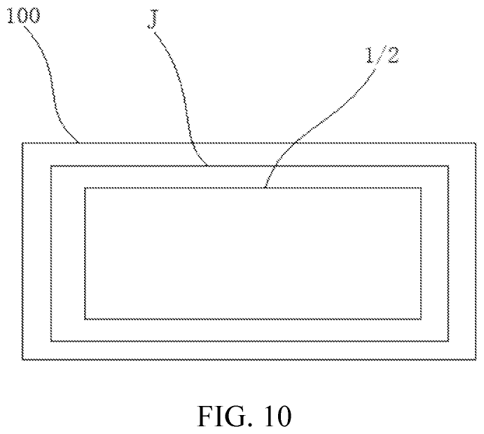

Referring to FIGS. 1 and 10, an embodiment of the present disclosure provides a battery 100. The battery 100 includes a battery casing K, a winding battery core J accommodated in the battery casing K, and a battery upper cover G. The structure of the winding battery core J provided in the embodiment of the present disclosure will be described later. The battery casing K can be a cylinder with an open upper end, and the inner wall at the bottom of the cylinder is electrically connected to a negative electrode current collection sheet of the winding battery core J. A boss T1 is provided at a central position of an outer bottom of the battery casing K, to connect a negative electrode of the battery to an external device. The battery upper cover G is a disc-shaped cover that matches the battery casing K, and has a bottom provided with a downwardly protruding plane that is electrically connected to a positive electrode current collection sheet. An insulating sealing ring is mounted between the positive electrode current collection sheet and the battery casing K. A cylindrical boss T2 protruding upward is provided at a central position on a top of the battery upper cover G, to connect a positive electrode of the battery to an external device. The battery upper cover G is provided with an electrolyte injection port D. The transmission of electrons between the positive and negative electrodes is achieved by injecting an electrolyte. After the electrolyte is injected, the electrolyte injection port is sealed with a sealing pin. The battery 100 with such a structure has less heat generation during the charge and discharge process, and low attenuation rate during cycles, allowing the battery 100 to have a long service life. By using the winding battery core J provided in the present disclosure, the wrinkling of the electrode sheet is reduced or even eliminated. This reduces the resistance of the battery 100, enables low heat generation of the battery 100, reduces the occurrence of exposed current collector caused by the falling off of the active material layer from the electrode sheet, and extends the service life of the battery 100.

Referring to FIG. 2, an embodiment of the present disclosure provides a winding battery core J. The winding battery core J includes a separator 3 and an electrode sheet 1 and an electrode sheet 2 provided in an embodiment of the present disclosure. The electrode sheet 1 and the electrode sheet 2 can be a positive electrode sheet and a negative electrode sheet. The separator 3 is usually a polymer material with nano-scale pores, and is provided between the electrode sheet 1 and the electrode sheet 2 to separate the two electrode sheets from each other, so as to avoid the short circuit caused by the contact between the positive and negative electrodes, and to permit the electrolyte ions to pass through. The electrode sheet 1, the separator 3, and the electrode sheet 2 are stacked, and then are wound by a special winding machine into the winding battery core J. By using the electrode sheet provided in the present disclosure, the wrinkling of the electrode sheet is reduced or even eliminated. As a result, the falling off of the active material layer from the electrode sheet is reduced, and the service life of the battery core is extended.

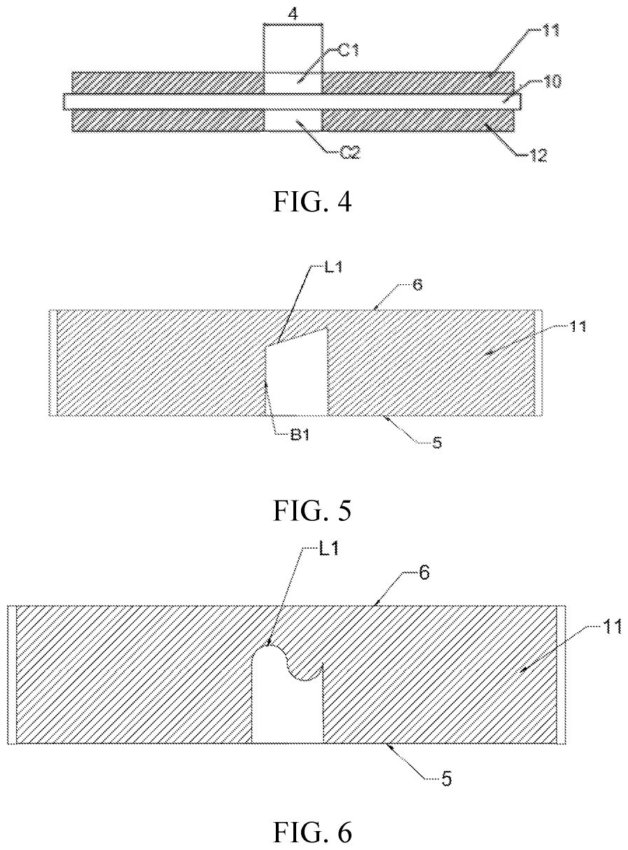

Referring to FIGS. 3 and 4, the present disclosure provides an electrode sheet, which includes a current collector 10 and a first active material layer 11 coated on a surface of the current collector 10. The first active material layer 11 is provided with a first groove C1, and the first groove C1 includes a first side wall B1, a second side wall B2 and a third side wall B3. The first side wall B1 and the second side wall B2 are arranged opposite and parallel to each other, and the third side wall B3 connects the first side wall B1 and the second side wall B2. The first side wall B1, the second side wall B2 and the third side wall B3 define the first groove C1. A vertical distance from the first side wall B1 to the second side wall B2 is the width 4 of the first groove C1. The shape of the orthographic projection of the third side wall B3 on the surface of the current collector 10 is a profile L1 of the third side wall B3, where the profile can be the surface contour of a cross-section view of the third side wall B3, and the length of the profile L1 is greater than the width 4 of the first groove C1.

By arranging the third side wall B3 having a profile L1 with a length that is greater than the width of the first groove C1, the perimeter of the first groove C1 is extended, so the area of the current collector 10 at the first groove C1 is increased. When rolled, the stressed area of the current collector 10 at the first groove C1 is increased, the pressure transmitted via the first active material layer 11 to the current collector 10 per unit area is reduced, so the current collector 10 is less extended, and the wrinkling of the current collector 10 is reduced.

In an embodiment, referring to FIGS. 3 and 5 to 8, the profile L1 of the third side wall B3 is a curve or a straight line. By arranging the profile L1 as a curve or a straight line, the stressed area of the current collector 10 is increased, so the pressure applied on the current collector 10 per unit area is reduced, thereby further reducing the extension of the current collector 10.

In an embodiment, referring to FIG. 5, if the profile L1 of the third side wall B3 is a straight line, the straight line is not perpendicular to the first side wall B1 and the second side wall B2, but inclined at an angle.

In an embodiment, referring to FIG. 3, the profile L1 of the third side wall B3 being a curve includes a situation where the profile L1 of the third side wall B3 is an independent arc. According to some embodiments of the present disclosure, the profile L1 is an arc with a radius that is half of the width 4 of the first groove C1. In this case, the perimeter of the first groove C1 is the longest, the stressed area of the current collector 10 at the first groove C1 is the largest, and the current collector 10 is least wrinkled. In other embodiments, the radius of the ac may be larger or less than half of the width 4 of the first groove C1.

In another embodiment, referring to FIG. 6, the profile L1 of the third side wall B3 may include an S-shaped curve. The S-shaped curve may include two semicircular arcs with the same diameter, and the diameter of the two semicircular arc is half of the width of the first groove C1.

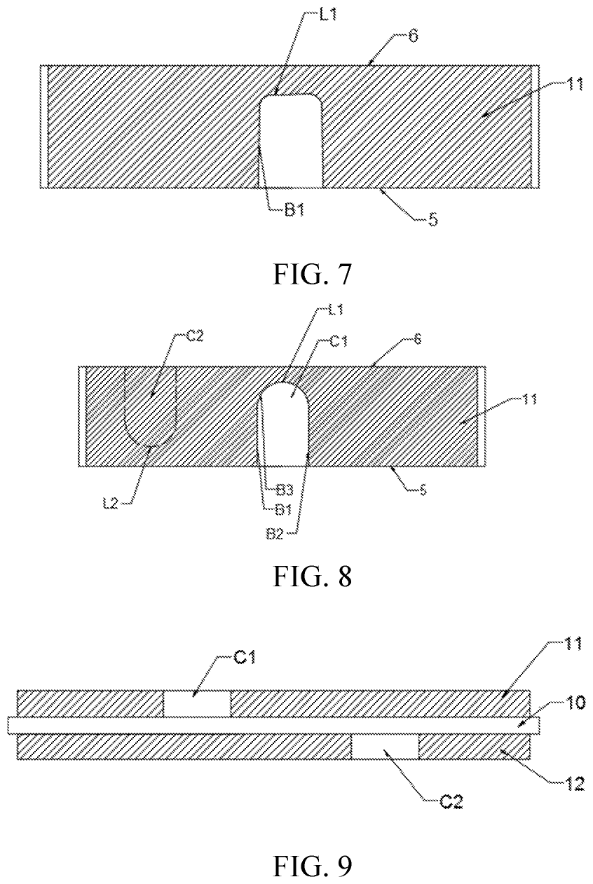

In another embodiment, referring to FIG. 7, the profile L1 of the third side wall may be a combination of an arc and a straight line. The arc can be a quarter arc, a semicircular arc or the like, and the straight line can be perpendicular or inclined to the first side wall B1. In other embodiments, the profile L1 of the third side wall B3 may include a free-form curve of any shape.

In an embodiment, referring to FIGS. 3 and 4, the current collector 10 includes a first side 5 and a second side 6 opposite to each other, and the first groove C1 and a second groove C2 extend from the first side 5 towards the second side 6. The profile L1 of the first groove C1 is a curve and the profile L1 of the first groove C1 is recessed from the first side 5 towards the second side 6. The second groove C2 has the same structure as that of the first groove C1.

In an embodiment, referring to FIGS. 8 and 9, the current collector 10 includes the first side 5 and second side 6, and the electrode sheet further includes a second active material layer 12. The second active material layer 12 is provided on a surface of the current collector 10 facing away from first active material layer 11, where the second active material layer 12 is provided with a second groove C2 that is the same as the first groove C1.

In an embodiment, referring to FIG. 8, the profile L1 of the first groove C1 extends from the first side 5 towards the second side 6, and the profile L1 of the third side wall B3 of the first groove C1 is recessed from the first side 5 towards the second side 6. The second groove C2 extends from the second side 6 towards the first side 5, and the profile L2 of the third side wall of the second groove C2 extends from the second side 6 towards the first side 5.

In an embodiment, referring to FIGS. 3 and 4, the first groove C1 and the second groove C2 are arranged right facing or in alignment with each other.

In an embodiment, referring to FIGS. 8 and 9, the first buffer portion C1 and the second buffer portion C2 are arranged to offset with each other.

The foregoing descriptions are merely some embodiments of the present invention, and does not limit the scope of the present disclosure. A person of ordinary skill in the art may understand all or some processes of the foregoing embodiments, and equivalent modifications made according to the claims of the present disclosure shall still fall within the scope of the present disclosure.

What is claimed is:

1. An electrode sheet, comprising a current collector and a first active material layer coated on a first surface of the current collector, wherein
the first active material layer comprises a first groove, and the first groove comprises a first side wall, a second side wall, and a third side wall,
the first side wall and the second side wall are arranged parallel to each other, the third side wall connects the first side wall and the second side wall, and the first groove has a width that is a distance from the first side wall to the second side wall, and
a length of a surface contour of a cross-section view of the third side wall is greater than the width of the first groove.

2. The electrode sheet according to claim 1, wherein the surface contour comprises a curve or a straight line.

3. The electrode sheet according to claim 2, wherein the curve comprises a first arc or a combination of a straight line and a second arc.

4. The electrode sheet according to claim 3, wherein a radius of the first arc is half of the width of the first groove.

5. The electrode sheet according to claim 1, wherein the current collector comprises a first side and a second side opposing to each other, the first groove extends in a direction from the first side towards the second side, and the curve is recessed towards the second side.

6. The electrode sheet according to claim 5, further comprising a second active material layer, provided on a second surface of the current collector opposite to the first surface of the current collector, wherein the second active material layer comprises a second groove.

7. The electrode sheet according to claim 6, wherein the second groove and the first groove are arranged in alignment or to offset with each other.

8. The electrode sheet according to claim 6, wherein the second groove extends in a direction from the second side towards the first side.

9. The electrode sheet according to claim 6, wherein the second groove and the first groove have a same shape.

10. A winding battery core, comprising a separator and two electrode sheets, wherein the separator is arranged between the two electrode sheets, and wherein each of the two electrode sheets comprises a current collector and a first active material layer coated on a first surface of the current collector,
the first active material layer comprises a first groove, and the first groove comprises a first side wall, a second side wall, and a third side wall,
the first side wall and the second side wall are arranged parallel to each other, the third side wall connects the first side wall and the second side wall, and the first groove has a width that is a distance from the first side wall to the second side wall, and
a length of a surface contour of a cross-section view of the third side wall is greater than the width of the first groove.

11. The winding battery core according to claim 10, wherein the surface contour comprises a curve or a straight line.

12. The winding battery core according to claim 10, wherein the current collector comprises a first side and a second side opposing to each other, the first groove extends in a direction from the first side towards the second side, and the curve is recessed towards the second side.

13. The winding battery core according to claim 12, wherein the electrode sheet comprises a second active material layer, provided on a second surface of the current collector opposite to the first surface of the current collector, wherein the second active material layer comprises a second groove.

14. The winding battery core according to claim 13, the second groove and the first groove are arranged in alignment or to offset with each other.

15. The winding battery core according to claim 13, wherein the second groove extends in a direction from the second side towards the first side.

16. A battery, comprising a winding battery core comprising a separator and two electrode sheets, wherein the separator is arranged between the two electrode sheets, and wherein each of the two electrode sheets comprises a current collector and a first active material layer coated on a first surface of the current collector,
the first active material layer comprises a first groove, and the first groove comprises a first side wall, a second side wall, and a third side wall,
the first side wall and the second side wall are arranged parallel to each other, the third side wall connects the first side wall and the second side wall, and the first groove has a width that is a distance from the first side wall to the second side wall, and
a length of a surface contour of a cross-section view of the third side wall is greater than the width of the first groove.

17. The battery according to claim 16, wherein the surface contour comprises a curve or a straight line.

18. The battery according to claim 16, wherein the current collector comprises a first side and a second side opposing to each other, the first groove extends in a direction from the first side towards the second side, and the curve is recessed towards the second side.

19. The battery according to claim 18, wherein the electrode sheet comprises a second active material layer, provided on a second surface of the current collector opposite to the first surface of the current collector, wherein the second active material layer comprises a second groove.

20. The battery according to claim 19, wherein the second groove and the first groove are arranged in alignment or to offset with each other.
